(19) United States
(12) Patent Application Publication
(10) Pub. No.: US 2018/0229744 A1
(43) Pub. Date: Aug. 16, 2018

(54) ENGINE MONITORING AND MAINTENANCE DISPATCH SYSTEM

(71) Applicant: Slick Technologies, LLC, Baltimore, MD (US)

(72) Inventors: Joseph R. MANZARI, Cockeysville, MD (US); Jonathan A. HALLSTEN, Barberton, OH (US); Nathan W. WRIGHT, Crossroads, TX (US); William R. SNYDER, Salem, OH (US); Steven R. NELSON, Copley, OH (US); Kevin C. STACEY, Mansfield, TX (US); Robert G. MARTINEZ, Akron, OH (US)

(21) Appl. No.: 15/865,609

(22) Filed: Jan. 9, 2018

Related U.S. Application Data
(60) Provisional application No. 62/457,362, filed on Feb. 10, 2017.

(51) Int. Cl. B61L 27/00; G07C 5/08; G07C 5/00; F01M 11/12

(52) U.S. Cl. CPC B61L 27/0094; G07C 5/0841; B61L 2205/04; G07C 5/006; F01M 11/12; G07C 5/008

(57) ABSTRACT

A method and system that monitors various functions and criteria within a standard vehicle platform (“SVP”) or a small engine platform (SEP″). The SVP uses an OBD-II adapter as a central controller to collect the information and communicate with a mobile communication device or a cloud based application to monitor the health of in-vehicle systems within the SVP and determine if maintenance is required. The SEP utilizes a run hour meter to collect information and communicates with a mobile communication device, an OBD-II adapter, or a cloud based application to monitor the health of an engine within the SEP and determine if maintenance is required. The method and system can automatically dispatch maintenance resources if maintenance is deemed necessary, thereby providing a managed maintenance solution for either a SVP or SEP.

### CROSS REFERENCE TO RELATED APPLICATIONS

This application is a non-provisional application that claims the benefit of U.S. provisional Application No. 62/457,362, filed on Feb. 10, 2017, the contents of which are herein incorporated by reference in their entirety.

FIELD

This invention relates to a communication enabled engine monitoring and maintenance dispatch system.

### BACKGROUND

Internal combustion engines typically utilize some type of natural or synthetic oil for lubrication of the engine's internal moving elements. This engine oil, over time, requires periodic maintenance, e.g., it has to be changed. Typically the maintenance interval is measured in hours of operation or in the case of a motor vehicle, on the distance driven. However, other factors such as oil temperature, ambient temperature, engine speed, and the type of oil used will alter the maintenance schedule of an engine.

Further, there are other components of an engine system that also play a crucial part in the smooth operation of an engine based system, such as the battery charging system and air filter components that require periodic maintenance.

### BRIEF SUMMARY

Given the foregoing, what is needed is a method and system for monitoring various functions and criteria within a device or vehicle that contains an engine, including internal combustion and electrical, such as oil levels, electrical systems, and environmental conditions. Further, the system needs to communicate, to and from an outside source, information concerning the monitored functions. Such communications provides information for further analysis to a central system and also allows the central system to communicate back to the monitoring system with the ability to dispatch resources as appropriate.

In an embodiment of the present disclosure, an engine platform system that consists of a standard vehicle platform (“SVP”) includes an on-board diagnostic (“OBD”) adapter designed to connect to a vehicle's OBD-II connector, power, sensors and a communications system. The OBD adapter receives information from a vehicle via the OBD-II connector and coupled with information received from sensors, determines a distance traveled by the vehicle. The OBD adapter transmits the vehicle's traveled distance information to a mobile communication device or a cloud-based application, wherein a determination is made whether the vehicle is in need of maintenance. If maintenance is required then that determination is sent to the OBD adapter with the option to automatically dispatch maintenance resources as appropriate.

According to another embodiment, there is provided a method for determining maintenance of a vehicle using a standard vehicle platform. The method includes the connection of an on-board diagnostic (“OBD”) adapter to an OBD-II connector in the vehicle. The OBD adapter generates a request to a computer within the vehicle and receives information related to maintenance of the vehicle via the OBD-II connector and determines an amount of distance traveled by the vehicle. The distance traveled and related maintenance information is sent to a mobile communication device and/or cloud application, wherein a determination is made whether the vehicle is in need of maintenance. The OBD adapter then receives information on regarding the need for maintenance with the option to automatically dispatch maintenance resources as appropriate.

In another embodiment of the present disclosure, an engine platform system that consists of small engine platform (“SEP”) adapter includes a run hour meter designed to connect to a device that includes an engine. The run hour meter includes sensors and a communications system. The run hour meter, using information received from the sensors, determines an amount of time the engine has been running. The run hour meter, using the communication system, transmits the engine's running time information to a mobile communication device or a cloud-based application, wherein a determination is made whether the engine is in need of maintenance. IF maintenance is required, that determination is sent to the run hour meter with the option to automatically dispatch maintenance resources as appropriate.

According to another embodiment, there is provided a method for determining maintenance of an engine using a small engine platform. The method includes the connection of an hour meter to a device with an engine. The hour meter, using its on-board sensors, determines engine maintenance information including an amount of time that the engine has been running. The run time information is sent to a mobile device and/or cloud application, wherein a determination is made whether the engine is in need of maintenance. The run hour meter then receives information on whether the engine is in need of maintenance with the option to automatically dispatch maintenance resources as appropriate.

In an embodiment of the present disclosure, there is an oil use monitoring and maintenance system that includes a vehicle with new oil holding tanks and waste oil storage tanks and an on-board control system. The on-board control system includes a processor with memory, sensors and a communications system. The sensors monitor oil levels in the new and waste tanks and also monitor oil inflow and outflow amounts. The communications system is designed for bi-directional communications with a mobile communication device and/or a cloud computing application and is configured to receive dispatch information and send status information. The system includes a maintenance fluid vacuum system where oil is drained from an engine and collected in a collection container connected to a waste oil tank through a top mounted waste recovery pump.

According to another embodiment, there is provided a method for oil use monitoring. The method includes the receiving of a dispatch request by a control system within an oil use monitoring system to a customer site. The dispatch instruction can be generated by a cloud application based on a maintenance request from a standard vehicle platform or a small engine platform system. The location of the desired SVP or SEP system is determined and the oil use monitoring and maintenance system travels to the appropriate location. Optionally, the location of the SVP or SEP can be included within the dispatch instruction. Maintenance is then performed on the SVP or SEP system where the oil use monitoring and maintenance system monitors inflow and outflow of oil from self-contained new and waste oil tanks. The method includes the transmission of status and oil use information to a mobile communication device and/or cloud.

Further features and advantages of the present disclosure, as well as the structure and operation of various embodiments of the present disclosure, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the present invention and to enable a person skilled in the relevant art(s) to make and use the present invention.

Additionally, the left-most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which are the same in structure, operation, or form but may be identified as being in different locations in space or recurring at different points in time (e.g., reference numbers ‘110a’ and ‘110b’ may indicate two different energy detection devices which are functionally the same, but are located at different points in a simulation arena).

FIG. 1 illustrates a standard vehicle platform with On-Board Diagnostic-II (“OBD-II”) monitoring and two-way communications, according to an embodiment of the present disclosure.

FIG. 2 depicts a standard vehicle platform OBD-II adapter, according to an embodiment of the present disclosure.

FIG. 3 depicts performance of a battery-charging system with trigger points, according to an embodiment of the present disclosure.

FIG. 4 depicts unit level analytic placement, according to an embodiment of the present disclosure.

FIG. 5 illustrates a system software architecture, according to an embodiment of the present disclosure.

FIG. 6 illustrates a small engine platform with monitoring and two-way communication, according to an embodiment of the present disclosure.

FIG. 7 depicts a detailed view of the hour meter in FIG. 6, according to an embodiment of the present disclosure.

FIG. 8 illustrates a small engine platform fleet monitoring system, according to an embodiment of the present disclosure.

FIGS. 9A, 9B and 9C illustrate an Oil Use Monitoring and Delivery system, according to an embodiment of the present disclosure.

FIG. 10 illustrates a flow chart of a method for determining maintenance of a vehicle using a standard vehicle platform, according to an embodiment of the present disclosure.

FIG. 11 illustrates a flow chart of a method for determining maintenance of a small engine platform, according to an embodiment of the present disclosure.

FIG. 12 illustrates a flow chart of a method for oil use monitoring and service, according to an embodiment of the present disclosure.

FIG. 13 illustrates an example computer implementation, according to an embodiment of the present disclosure.

Further embodiments, features, and advantages of the present invention, as well as the operation of the various embodiments of the present invention, are described below with reference to the accompanying figures.

### DETAILED DESCRIPTION OF THE INVENTION

While embodiments described herein are illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, it is understood that it is within the knowledge of one skilled in the art to affect such feature, structure, or characteristic in connection with other embodiments whether or not explicitly described.

The engine monitoring and maintenance system includes a multiple of peer components that are designed to work in concert with each other as part of service jobs. In some embodiments the individual components are self-sufficient, in other embodiments multiple components work in combination. Embodiments are generally directed to two engine platform systems, the standard vehicle platform (“SVP”) and the small engine platform (“SEP”). However, an engine or vehicle is not to be limited, but can apply to any type of mechanical contrivance including those vehicles or devices powered by electricity, gasoline, propone, or any other type fuel.

The SVP includes an On-board diagnostics-II (“OBD-II”) port and a communications element. The OBD-II connection allows the SVP to communicate with a vehicle's self-diagnostic and reporting system. Typical OBD-II implementations provide real-time data on the operating environment within a vehicle in addition of a standardized series of diagnostic trouble codes that identify malfunctions within the vehicle. The OBD-II standard specifies the type of diagnostic connector and pinout functions in the connector. Typically vehicles equipped with an OBD-II connector have the connector located within two feet of the steering wheel. Instead of the OBD-II standard, some embodiments utilize the European On-Board Diagnostic (“EOBD”) standard, which is the European equivalent of the OBD-II standard, or the “JOBD” for vehicles sold in Japan, or the ADR 79/01 and 79/02 for those vehicles using the Australian standard.

In addition to having the SVP communicate with a vehicle using the OBD-II communications link, the SVP can also communicate with a central system using an on-board communications system such as Bluetooth low energy (Bluetooth LE, BLE or Bluetooth Smart), WiFi, cellular, or any other type of wireless communication. The SVP can also communicate with a mobile communication device and corresponding mobile application, a central system via the Internet or using cloud computing. The SVP may also communicate with a mobile service vehicle through the use of a vehicle-mounted control box that will be discussed later in further detail.

The SEP components include an hour-meter with a communications element that can be used to communicate as described with the SVP using Bluetooth low energy (Bluetooth LE, BLE or Bluetooth Smart), WiFi, cellular, or any other type of wireless communication. As with the SVP, the SEP can also communicate with a mobile communication device and corresponding mobile application, a central system via the Internet or using cloud computing.

SVP System

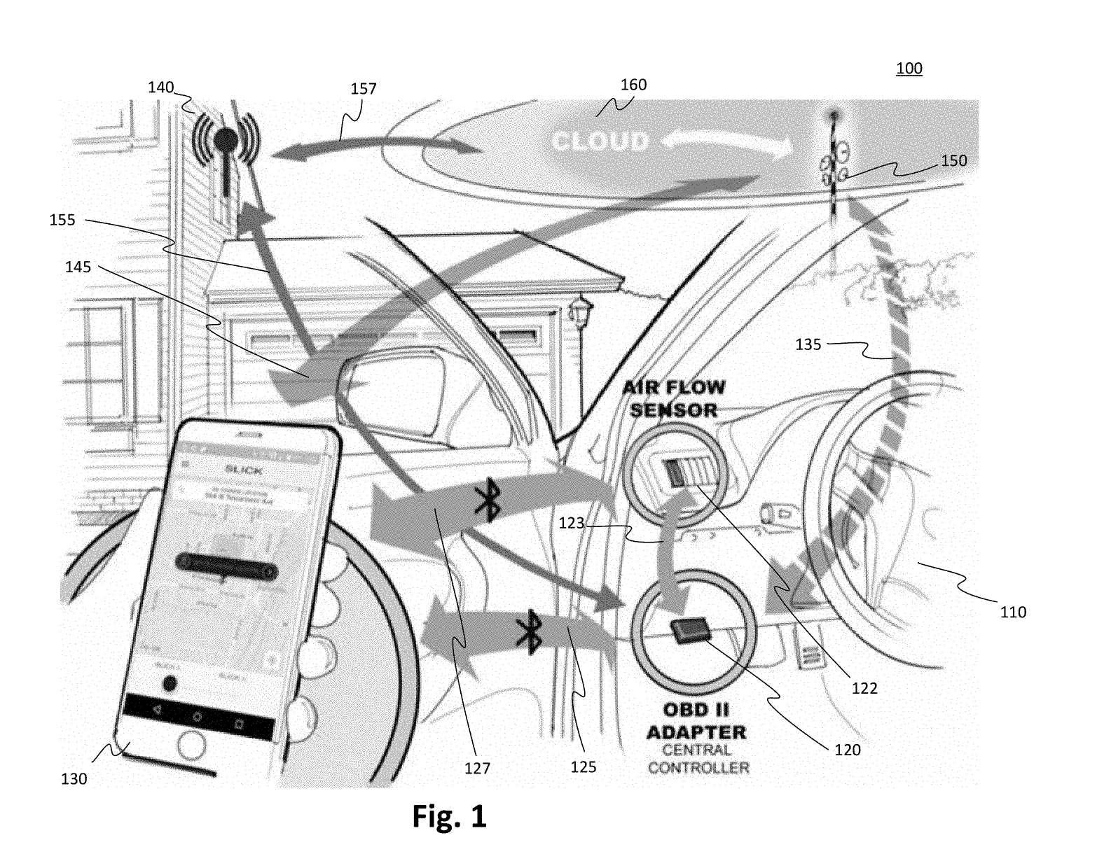

FIG. 1 illustrates a SVP system 100, according to an embodiment. SVP system 100 includes a vehicle 110, an OBD-II adapter 120, an air flow sensor 122, a mobile communication device 130, a WiFi hotspot 140, a cellular tower 150 and access to cloud computing 160 offering a technology driven managed maintenance platform for vehicles. OBD-II adapter 120 is a central controller that captures information from vehicle 110 through vehicle 110's OBD-II connector (not shown). OBD-II adapter 120 gathers parameter identifier codes (“PID”) from vehicle 110 to calculate real-time odometer values. OBD-II adapter 120 can also capture any other relevant PID codes and store those in its internal memory, and/or communicate the information in real time to mobile communication device 130 or cloud 160. Communications can include any type or protocol including, but not limited to, WiFi, cellular, LoRa, SIGFOX or any other communications stand using licensed or non-licensed frequency bands.

OBD-II adapter 120 can communicate its captured information to cloud 160 in real time for further analysis via multiple pathways. In one embodiment, OBD-II adapter 120 communicates with mobile communication device 130 via Bluetooth pathway 125. Mobile communication device 130 contains an SVP application, either iOS or Android based or any other mobile communication device operating platform, which serves as a user's interface to SVP system 100. The application allows a user to view the information gathered by OBD-II adapter 120 and also allows the user to access a SVP cloud based application to perform various functions such as monitoring and maintenance functions associated with vehicle 110. Such access to cloud 160 would be via cellular pathway 145 and cellular tower 150.

In an embodiment, access to cloud 160 can also be accomplished directly from OBD-II adapter 120 to cloud 160 through cellular connection pathway 135, or through WiFi hotspot 140 using pathways 155 and 157.

SVP system 100 also illustrates communications originating from cloud 160 to OBD-II adapter 120. Such two way communications allows for commands and instructions to be received by OBD-II adapter 120 from cloud 160, such as updating maintenance information data or commands to OBD-II adapter 120. Such communications can also be directed from cloud computing on cloud 160 to mobile communication device 130 running the SVP application, either directly via pathway 145 or routed through OBD-II adapter 120 using pathways 135 and 125.

Air flow sensor 122 monitors the flow of air into the cabin of vehicle 110. Air flow sensor 122 is shown located in the driver's side air vent, but could be located anywhere within the environmental control system of a vehicle. Air flow sensor 122 communicates with OBD-II adapter 120 to pass on its sensor readings pertaining to air flow. Air flow sensor 122, in an embodiment, can also communicate with mobile communication device 130 using Bluetooth pathway 127.

Air flow sensor 122 can be used to detect harmful particulates, including combustible particulates, e.g., from cigarette or cigar smoke. The use of air flow sensor 122 could therefore be used by a fleet management company to monitor compliance with a “no smoking” in the vehicle rule. Or, similarly a car rental company could use the information detected by air flow sensor 122 to levy a “cleaning” fee for smoking in a no-smoking allowed vehicle. Air flow sensor can consists of any of a number of sensor types including but not limited to infra-red (IR), metal oxide gas, or a gas particulate sensor or the like. In an embodiment air flow sensor 122 is placed in the path of an air vent. In another embodiment air flow sensor 122 includes a self-contained fan to draw cabin air into the sensor for analysis. Air flow sensor 122 can exist as a standalone device containing communication capabilities to accept commands and send information. Or, air flow sensor 122 could be incorporated into an OBD-II style module or configured as a Bluetooth accessory to a smart phone. A detection algorithm is used to determine a base line dust and sensor noise level, e.g., threshold, such that an accurate level of particulate detection is achieved. In other words, the “base line” is not necessarily zero as some amount of dust and/or particulates exist in a vehicle, especially based on where air flow sensor 122 is place, e.g., under the dashboard.

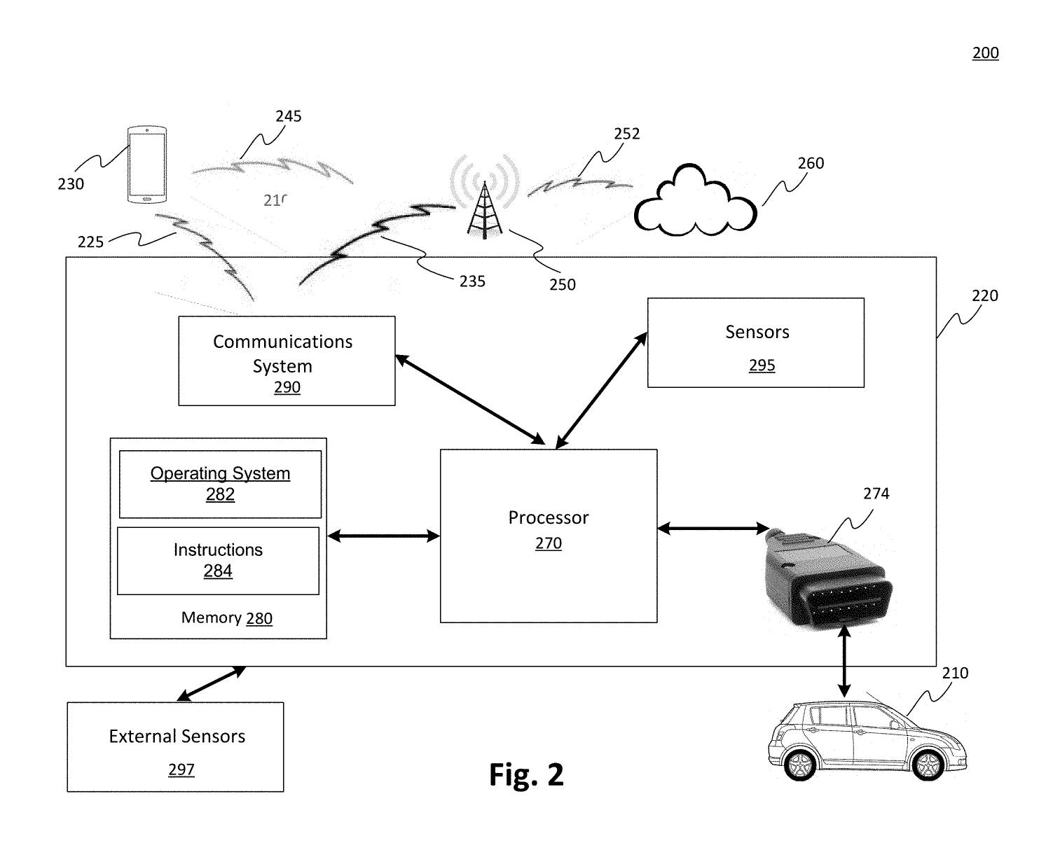

FIG. 2 illustrates a SVP system 200, according to an embodiment. SVP system 200 includes a vehicle 210, an OBD-II adapter 220, a mobile communication device 230, a cellular tower 250 and access to cloud computing 260 through cellular pathway 252. SVP system 200 presents another embodiment of a technology driven managed maintenance platform. OBD-II adapter 220 includes a processor 270, memory 280 containing both operating system memory 282 and instructions memory 284, a communications system 290, and an OBD-II connector 274 that connects to an OBD-II connector in vehicle 210. OBD-II adapter 220 can also, through communications system 290 communicate directly to cloud 260 through cellular pathways 235 and 252. OBD-II adapter 220 also includes sensors 295, or external sensors 297, to detect various movement and environmental conditions, e.g., acceleration, vibration, gyroscopic, tilt, humidity, proximity movement, temperature, air quality, acoustic, smoke, microphone, carbon monoxide, impact, occupancy, altitude, etc.

OBD-II adapter 220 can also be configured to include one or more multicolor red-green-blue (RGB) light-emitting-diodes (LEDs), in an embodiment (not shown in FIG. 2). The one or more multicolor LEDs can be used to communicate visually to the user. Such communication can include system status including that the unit is active, communicating, and/or in an alert status. Optionally, OBD-II adapter 220 can be configured with a display screen, for example an LCD panel to display status and connectivity.

OBD-II adapter 220 receives data and power from monitor vehicle 210's OBD-II connector. However, OBD-II adapter 220 could include an auxiliary power source (not shown) so as to not be dependent on monitor vehicle 210's power. Such a power source could include replaceable or rechargeable batteries. OBD-II adapter 220 contains memory 280 that has operating system memory 282 and instructions memory 284. Memory 280 is configured to preserve information for at least 10 different vehicles. OBD-II adapter 220 is able to calculate real-time odometer values, and has the ability to receive new functionality to be stored in instructions memory 284 in the form of firmware updates.

OBD-II adapter 220 receives data via OBD-II connector 274 from vehicle 210 based on the OBD-II publicized standard. However, this standard fails to define an exact odometer reading, e.g., 101,200 miles. To compensate for this lack of actual odometer information, OBD-II adapter 220 receives the “distance (km) traveled since codes cleared” OBD-II PID code, which is a 2 byte read at 0x31 hex, which when added to a baseline value entered by a user or technician, which yields an actual odometer reading. Once OBD-II adapter 220 determines the actual reading that information can be transmitted to cloud 260 and/or mobile communication device 230. Further, cloud 260 and/or mobile communication device 230 can store any baseline value and have knowledge of the distance traveled since codes cleared and determine the actual odometer value.

SVP system 200 is also configured to provide predictive maintenance with respect to machine learning for vehicle service and failure prevention, according to an embodiment. Using OBD-II adapter 220 to actively monitor sensors and non-critical failure notifications from the SVP data bus, SVP system 200 can analyze and predict and anticipate future failures. Thus, preventative maintenance can be performed before an actual failure occurs.

An example predictive maintenance factor is an engine low temperature condition. Typically, such a condition will not cause the “check engine” light to illuminate. However, low engine temperature can impact the engine's efficiency and ability to run the vehicle's cabin heater. A low temperature engine condition can be detected through a P0128 thermostat OBD-II trouble code indicating that the engine's powertrain control module has detected that the engine has not reached the required temperature level within a specified amount of time after starting.

Another example factor is low oil pressure. Low oil pressure can be a sign of contaminated oil and can be detected by reading a P0522 OBD-II diagnostic trouble code when the powertrain control module senses too low of a value in the engine oil pressure sender/sensor.

Another example factor is detection of a low transmission fluid level where early detection can prevent major repairs. A low transmission fluid level condition can be detected through a P070C transmission fluid level sensor circuit low OBD-II trouble code indicating that the transmission fluid is below a threshold level.

Other possible example factors include early detection of a tire leak. Tire air pressure can be monitored over time. By tracking pressure over time, rather than just a limit trigger, a steady decrease in pressure can be indicative of a tire leak. Oil change frequency can be predicted based on driving conditions and driving behavior, rather than just the number of driven miles. And, engine efficiency can be tracked based on monitoring engine air filters, oxygen sensor, and other vehicle sensors.

Predictive analysis includes aggregates data from multiple sources and can include what is known from the vehicle's OBD-II data bus and what is known from separate vehicle sensor. This data can then be compared to known data from larger vehicle fleet failure instances. In addition to the above mentioned OBD-II codes, further diagnostic determinations can be made based on vendor specific OBD-II data bus values and enhanced with other sensor historical data and machine learning data.

As an example, an in-line sensor could be inserted in the power line from a vehicle's battery. The in-line sensor can monitor voltage and current levels during start-up of the vehicle. The levels and timing of the starting voltage and current can be compared with known data of a properly functioning and failing starting system to determine if the battery is beginning to fail. ODB-II adapter 220 could also be used to provide remote access relating to control of windows, lights, horn and other related functionality, via the SVP data bus. Likewise, ODB-II adapter 220 could provide last known vehicle location with respect to GPS data coordinates.

Further, the OBD-II standards currently reset the distance traveled code after 65,535 km to zero or by a two byte 0xFFFF hex value. In addition, the reading can be manually cleared. To compensate for this limitation in the OBD-II standards, OBD-II adapter 220 performs the following:
Records are maintained for at least 10 vehicles where the VIN number is the key to each record entry.
An age parameter is stored such that the oldest record is set and checked. The oldest record is discarded when the device is plugged into a new 11th vehicle (or one more than the maximum number of vehicles stored).
Since the records are stored in memory 280, e.g., flash memory, they are maintained in a ping pong configuration that is only updated on specific events, such as new VIN number, operator entered a new mileage value, kilometer rollover or reset.
In the record set there is also a cumulative kilometers value. This is zero initially when the device is first plugged in. This can be updated if the user/technician enters a new mileage value.
There is a separate flash area in memory 280 that stores the kilometers read in a logging fashion on an ongoing basis. If the device is plugged into another vehicle then the last value will be stored in the record set for next time and this logging flash area is erased for the new VIN record. If this logging flash area fills then the ping-pong record is also updated and that area can be erased and used again.
Accordingly, the actual kilometers are cumulative kilometers plus currently read kilometers.
There is no difference between a rollover and a reset. If at any time the kilometers read is less than the previous value of kilometers read then the cumulative value is updated with the previous value and the actual kilometers will still be cumulative kilometers plus currently read kilometers.

Once the distance traveled by the vehicle is determined, that information can be sent to mobile communication device 130 or directly to cloud 160. In either case the distance traveled is compared to predetermined information pertaining to the year, make and model of vehicle 110 to determine if maintenance is required. If maintenance is required then an indication can be sent back to OBD-II adapter 120 and/or mobile communication device 130 for further action.

In an embodiment, the further action can include the dispatching of maintenance resources, e.g., a vehicle equipped with the appropriate tools and supplies to service the vehicle. The system can also automatically generate possible service appointment times that would be presented to a user for selection, or it can simply schedule a time to perform the work without the user's input. This “managed” approach to vehicle maintenance is pro-active and self-aware, eliminating the need for the user of the vehicle to constantly monitor the vehicle and make arbitrary maintenance decisions.

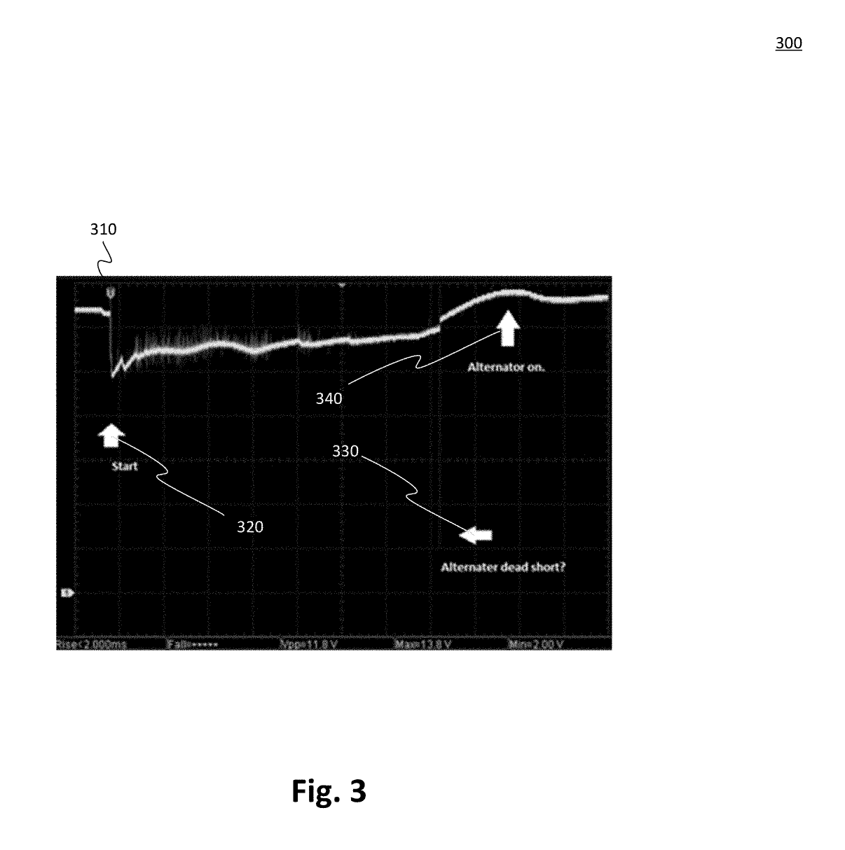

FIG. 3 illustrates a SVP system 300 electrical system analysis, according to an embodiment. In addition to capturing odometer telemetry, OBD-II adapter 220 has the ability to monitor vehicle 210's main battery and charging system health. The system can also recommend if further services are needed. Pin 16 of OBD-II connector 274 is connected to monitor vehicle 210's battery. OBD-II adapter 220 monitors at least pin 16, prior to starting, during starting, and after a charging system engages, e.g., when the alternator starts, to determine the health of the battery/charging system

FIG. 3 illustrates a waveform of the battery's voltage versus time during starting of the engine. OBD-II adapter 220 would access, either via pre-stored in its memory, or via cloud 260, the expected engine cranking amps of vehicle 210 and other factors such as ambient temperature. Temperature information can be obtained from a vehicle's inherent temperature sensor via the OBD-II appropriate PID and/or via a temperature sensor on the OBD-II adapter 120. A healthy waveform of a vehicle with a low ambient temperature is very different from a healthy waveform of a vehicle with a high ambient temperature.

Knowing this information, OBD-II adapter 220 can produce a picture of what a good healthy battery/charging system start waveform should look like and determines the proper start voltage, voltage drop depth, voltage recovery, alternator kick-on, etc. OBD-II adapter 220 can also determine if waveforms captured in FIG. 3 indicate an improper value. Waveform history comparison can also be used as well as pulling relevant PID values (standard or vendor specific) to further improve the analysis.

OBD-II adapter 220 analyzes the voltage level of vehicle 210 at three specific points. The first is shown at prior to point 320 as a battery open-circuit, e.g., when the vehicle is off The next is the period between points 320 and 330 when the engine is started where the battery cranking voltage drops, prior to the alternator starting. And, then at point 340 and beyond, when the alternator engages and the electrical system starts charging. Such data can then be analyzed by OBD-II adapter 220 by comparing the analysis points to predetermined thresholds in memory 280 to determine if a “fail” trigger should be generated. In the alternative, the data can also be sent to mobile communication device 230 and/or cloud 260 for an application in either mobile communication device 230 or cloud 260 to determine if a “fail” trigger is to be generated. In an embodiment, cloud 260 or mobile communication device 230 makes the “failed” determination and communicates the results back to OBD-II adapter 220.

In addition to odometer and battery/charging system analysis, OBD-II adapter 220 can monitor vehicle 210's air filters, e.g., engine and cabin, and notify when service is required. The quality of the cabin air filter would be accomplished by a battery operated wireless sensor mounted to an air duct in the vehicle that sends data to either OBD-II adapter 220 or to mobile communication device 230 via wireless communications such as Bluetooth (BLE). As it is known when the air filters are installed, a baseline air flow performance is captured and stored in memory 280. Then, through OBD-II connector 274 to vehicle 210, the degradation of the air flow performance of the system over time as compared to the baseline is captured. For the case of the engine air filter, this is accomplished by monitoring the PID values (0x50, 0x66, etc.) and with possible input regarding driving behavior and location/terrain, altitude, etc. For the case of the cabin air filter, the information is sent to OBD-II adapter 220 from the battery operated wireless sensor. When the air flow performance decreases below a predetermined threshold a “failed” air performance determination is generated. Such a determination can be sent to mobile communication device 230 and/or cloud 260. Subsequently, cloud 260 can generate a response and instructions to be sent back to OBD-II adapter 220.

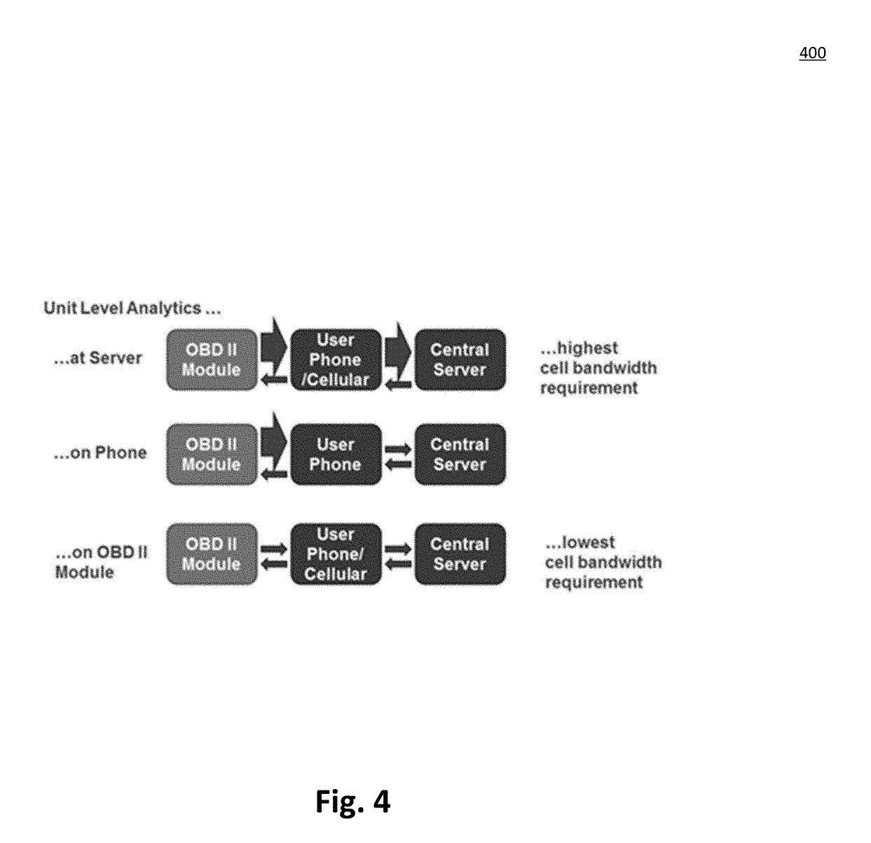

FIG. 4 illustrates data flow and unit level analytics between various components in a SVP system 400, according to an embodiment. FIG. 4 illustrates a tradeoff between data bandwidth and processing capability. More data from mobile communication device 230 to cloud 260 via cellular pathways 225, 245 and 252 or directly to cloud 260 via cellular pathways 235 and 252 will drive up cellular bandwidth costs. Note that the thickness of the arrows in FIG. 4 is indicative of data pipeline band. In an embodiment the analytics would reside on OBD-II adapter 220 and/or mobile communication device 230 were only alert data is communicated to cloud 260, resulting in lower data costs. However, once an alert is triggered by OBD-II adapter 220, cloud 260 communicates with OBD-II connector 274 to proceed into a higher data diagnostic mode where larger than normal data is sent to cloud 260 for more thorough analysis with significantly higher computation power and/or where a technician can get a diagnostic snapshot prior to being dispatched.

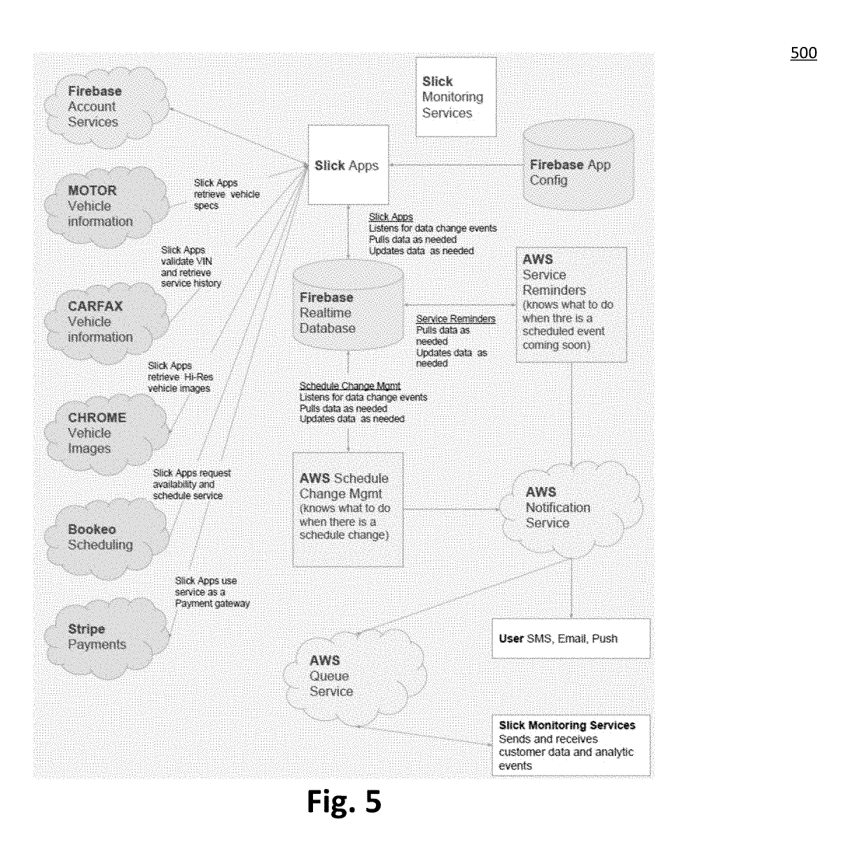

FIG. 5 depicts software architecture for SVP system 500, according to an embodiment. SVP system architecture includes Infrastructure and services for displaying the real time vehicle dashboard to the end user. The user will also be able to schedule maintenance through the dashboard app. The core component of the dashboard is the real-time database, which provides synchronous data transfer between the end-user dashboard and the Slick technician app on mobile communication device 230. The dashboard relies on third party applications for payment processing and managing technician schedules. It also integrates with other third party databases for vehicle data. Supporting business functions for advanced scheduling are hosted on third party Internet web services.

SEP System

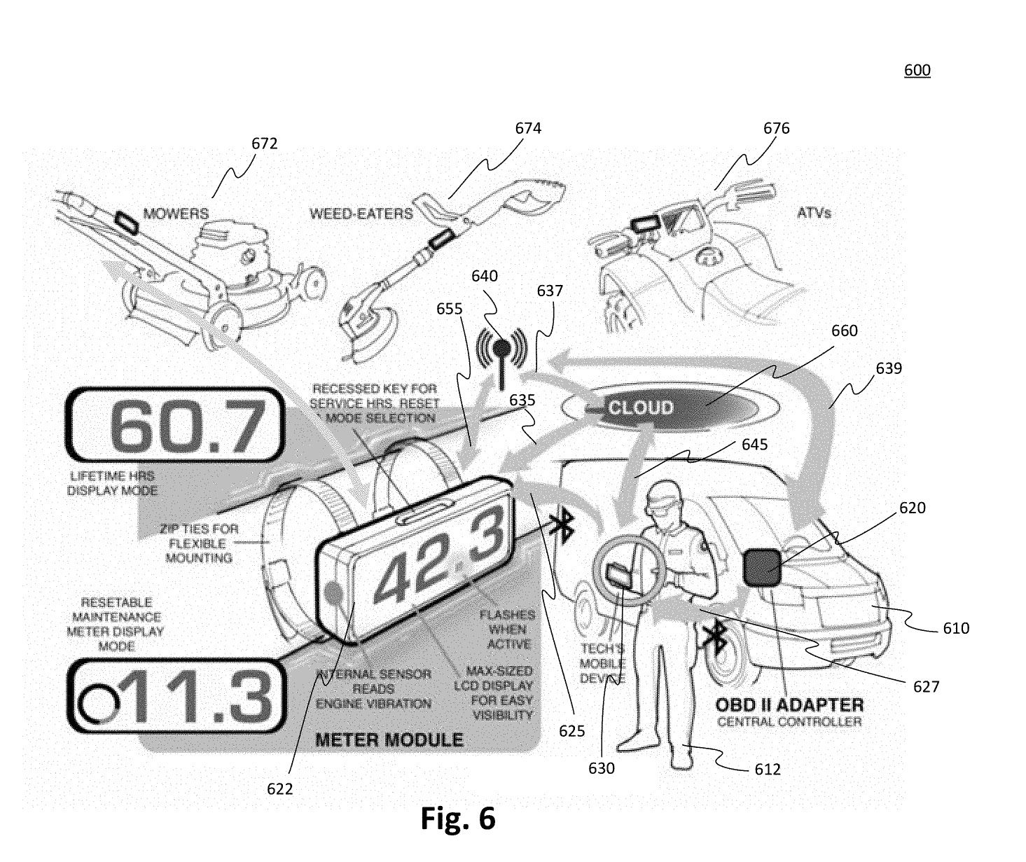

FIG. 6 illustrates a SEP system 600, according to an embodiment, offering a technology driven managed maintenance platform for small engine platform systems. SEP system 600 includes a maintenance dispatch vehicle 610, technician 612, an OBD-II adapter 620, a run hour meter 622, a mobile communication device 630, a WiFi hotspot 640, and access to cloud computing 660. Run hour meter 622 is also shown in a number of other embodiments, including mounted on a mower 672, a weed-eater 674 and an ATV 676.

Cloud computing 660 can be configured to provide scalable, reliable services and data analysis tools to power applications and devices for SEP system 600. The primary goals of cloud computing 660 include the following:
support of mobile application functionality;
support of continuous collection of telematic data;
providing of real time monitoring of data; and
providing real time notification of important events.

Cloud computing 660 can also be configured to provide monitoring services to handle data events transmitted from the devices such as mower 672, a weed-eater 674 and an ATV 676. The services are exposed via an API Gateway and then delegated to specific container-based services. The services will use specific analysis functions to evaluate the stream of data and emit events based on decision processing, e.g. what is the trending air quality of air flow sensor 122 or the length of time on run hour meter 622.

Cloud computing 660 utilizes application services to provide authentication, data storage, configuration, analytics and web hosting. Application services are applicable for both technician and consumer applications and include features such as:
account management;
offline storage;
real-time data synchronization;
data scalability; and
data security.

Further, the application services and monitoring services of cloud computing 660 interact such that a mobile application running on mobile communication device 630 will expose data and events so the monitoring services can consume them and process accordingly.

Cloud computing 660 is also applicable for fleets of vehicles and includes fleet centric component. Thus, cloud computing 660 includes extensions that allow larger groups of vehicles to be managed and tracked accordingly. These extensions include standalone modules to allow a fleet to:
provision and manage vehicles;
add a vehicle via a camera scan;
lookup vehicle via Vehicle Identification Number (VIN);
lookup vehicle images via VIN or by year, make and model;
lookup vehicle specs and maintenance routines;
lookup available products/services;
schedule a service;
correctly invoice and charge a fleet for vehicle service;
provide notifications of completion and service report;
publish vehicle service information to third party services; and
provide web and mobile applications.

Run hour meter 622 has the ability to communicate with mobile communication device 630 through a Bluetooth pathway 625 and then from mobile communication device 630 through pathway 645 to cloud 660 (using a cellular communication tower, not shown). Run hour meter 622 could also connect directly to cloud 660 through pathway 635, or via WiFi hotspot 640 through pathway 655. All communication pathways are bi-directional allowing information to flow from run hour meter 622 to mobile communication device 630 and to cloud 660, as well as from cloud 660 back to run hour meter 622. All discussion relating to run hour meter 622 is also completely applicable to the hour meter embodiments shown in 672, 674 and 676. Run hour meter 622 also contains a power source (not shown).

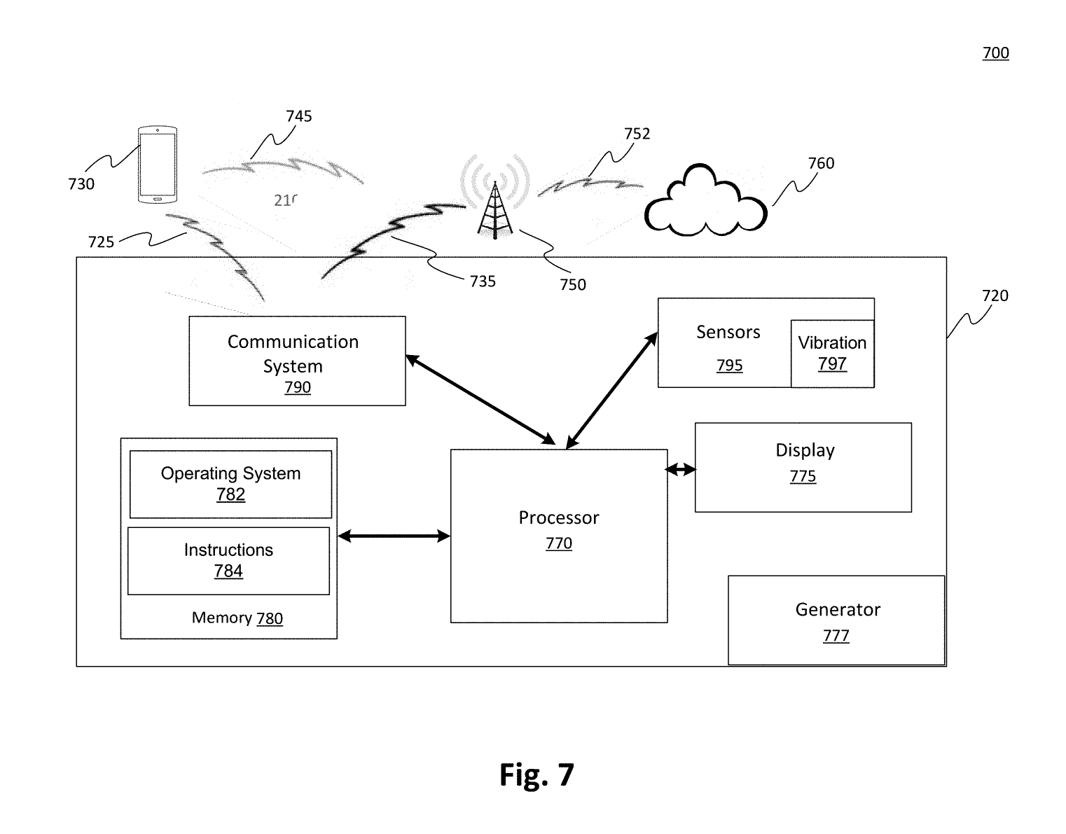

A more detail view of run hour meter 622 is shown in FIG. 7 with SEP system 700, according to an embodiment. SEP system 700 includes run hour meter 720 that can communicate with mobile communication device 730 through pathway 725 and then through pathway 745 to cellular tower 750 and then through pathway 752 to cloud 760. Run hour meter 720 can also communicate directly with cloud 760 through pathway 735 to cellular tower 750 and then through pathway 752.

Run hour meter 720 includes a processor 770, a display screen 775, a generator 777, memory 780, a communication system 790 and sensors 795. Sensors 795 are designed to detect vibration and hence determine the time that SEP system 700 has been running. In addition to detecting vibration, sensors 795 can detect ambient temperature and the actual revolutions per minute of SEP system 700.

In an embodiment, sensors 795 in run hour meter 720 include a vibration sensor 797. The vibration sensor is configured to detect both engine activity as well as user generated control via a series of “taps.” With the engine in a stopped state, the vibration detection sensor can detect a “tap” where run hour meter 720 can be controlled by recognizing one or more taps. The number of taps correlates to a desired function. For example, the detection of 3 taps while the engine is in a non-active state would start the engine. Conversely, for example, 3 taps would instruct the engine to stop if the engine is active. Sensor 795 is configured to discern a difference between a “tap” and the normal vibrations associated with the engine running. Once the engine is running, subsequent taps can also be configured for other functions. For example, a single tap could cause a display panel to cycle through its settings such as the current run time, total run time, status, etc. The use of vibration sensor 797 also eliminates the need for a physical button for such control.

Display 775 is used to communicate information to a user, such as the length of time SEP system 700 has been running, the ambient temperature, the average or maximum revolutions per minute (RPM) of SEP system 700, and the percentage of oil life remaining. Such information can also be sent to cloud 760 or mobile communication device 730 for further analysis. The percentage of oil life remaining can be calculated as the time from the last oil change as compared to the recommended oil change hour interval from the manufacturer. Such information can be obtained by run hour meter 720 through its communication system 790 to mobile communication device 730, or to cloud 760. A more accurate calculation of remaining oil life can be determined taking into account ambient temperature and average RPM. Basing oil changes on just run hours does not take include factors such as the stress level of the engine, e.g., run hours during idling versus those running at high RPM and heavy loads are vastly different, and those hours occurring during high ambient temperatures are also more stressful on the engine, and therefore require a more frequent oil change maintenance schedule. Such determinations can be made by mobile communication device 730 or cloud 760 and then communicated back to run hour meter 720, with the ability to display such information on display 775.

Run hour meter 720 can also include other features such as:
A button to change modes on the side of the enclosure;
Large fonts on the screen which are dynamic sized based on the number shown (10 would take up more space with a larger font then 10000 would for instance);
Decimal accuracy to the 100th place;
A decimal point icon that flashes when activity is detected; and
An ambient light sensor which may turn a backlight on the LCD when in dark environments and use is detected.

Further, processor 770 executes algorithms stored in memory 780 through instructions 784, under the control of operating system 782. In an embodiment, a detection algorithm is executed that distinguishes, through the use of sensors 795, the difference between real engine/motor vibrations as compared to other movements such as walking with the SEP or having the SEP riding in a truck, with its own engine off. Such an algorithm would also contain a “learn” mode where with run hour meter 720 installed on a device, such as mower 672, in learn mode through sensors 795 and display 775 would instruct the user to take the engine in the SEP from an “off” vibration baseline to an engine/motor “on” snapshot when the motor is running. Such sensor input would then be programmed into an updated algorithm, either directly into instructions 784, or through unlinking to mobile communication device 730 or cloud 760 and downloading the updated algorithm from the same.

Run hour meter 720, in an embodiment, contains generator 777 that is used to charge a power source (not shown) that powers the components within run hour meter 720. Generator 777 can be a piezoelectric electric generator that will charge the internal power source when being vibrated. Processor 770, with instructions 784 can also be configured to execute a battery management program that minimized power draw. The power source in run hour meter 720 may also be serviceable and could be replaced by a user and/or service personnel. Further, the run hour meter 720 housing is intended to be waterproof, uV resistant, and specifically designed so that it can be mounted rigidly to the monitored device and the case is designed in such a way that the vibration is appropriately “transferred and seen” by the vibration sensor(s) within run hour meter 720. Further, the electric generator can either charge the power source and/or power the electronics directly or any combination thereof.

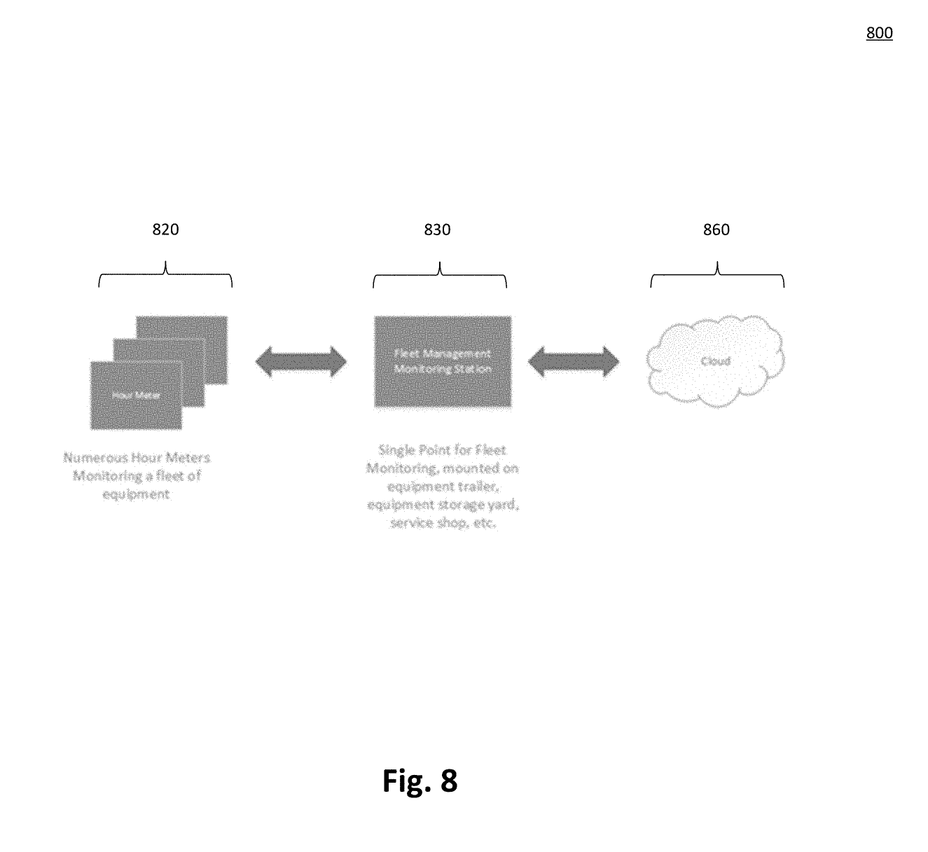

FIG. 8 illustrates a SEP system 800, according to an embodiment. SEP system 800 is an illustration of a fleet monitoring system. For example, referring to FIG. 6, one can envision run hour meter 622 attached to multiple objects, such as mower 672, weed-eater 674 and ATV 676. Multiple devices with attached hour meters are considered to be a fleet of equipment and labeled as element 820 in FIG. 8. The single point for monitoring the fleet of equipment in 820 is shown as element 830 and can consist of any single point with which the elements of 820 can communicate such as a mobile communication device 630 carried by a technician 612, and then to cloud 860. Or, if the hour-meters are equipped with cellular communications, then they could communicate directly with cloud 860. In either case, cloud 860 would collect data from each hour-meter and have the ability to send pertinent information back to each hour-meter.

Oil Use Monitoring and Maintenance

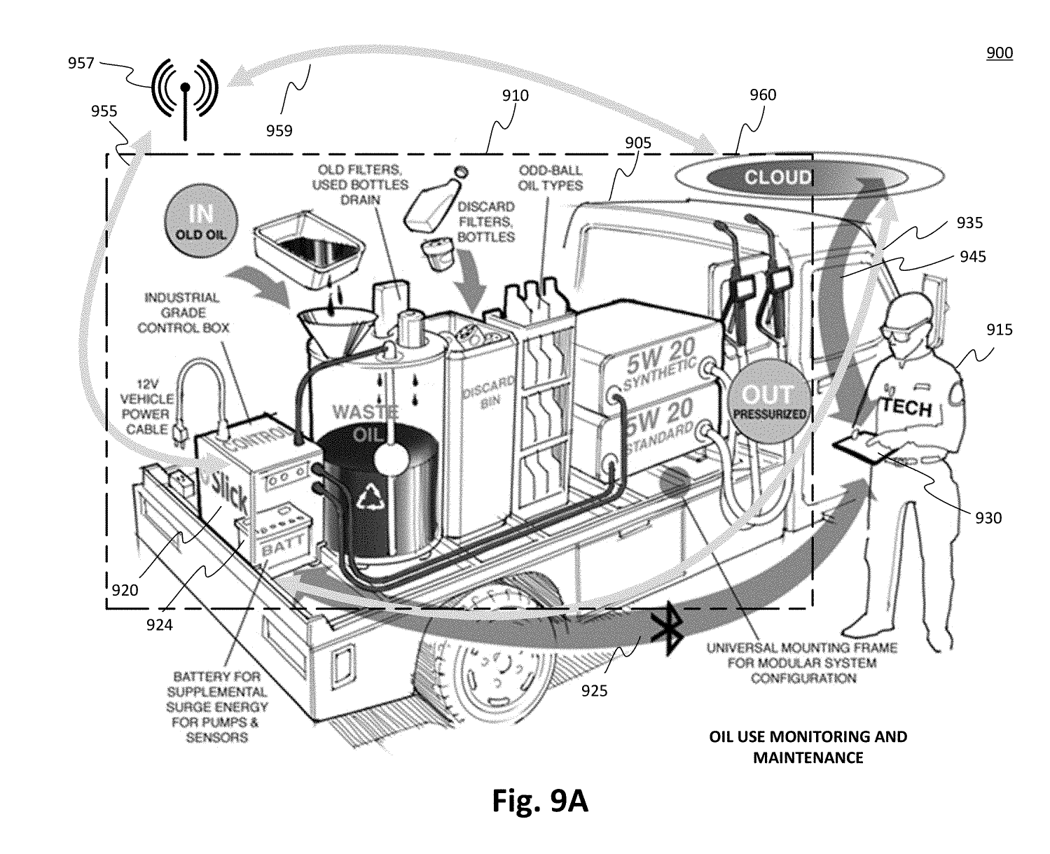

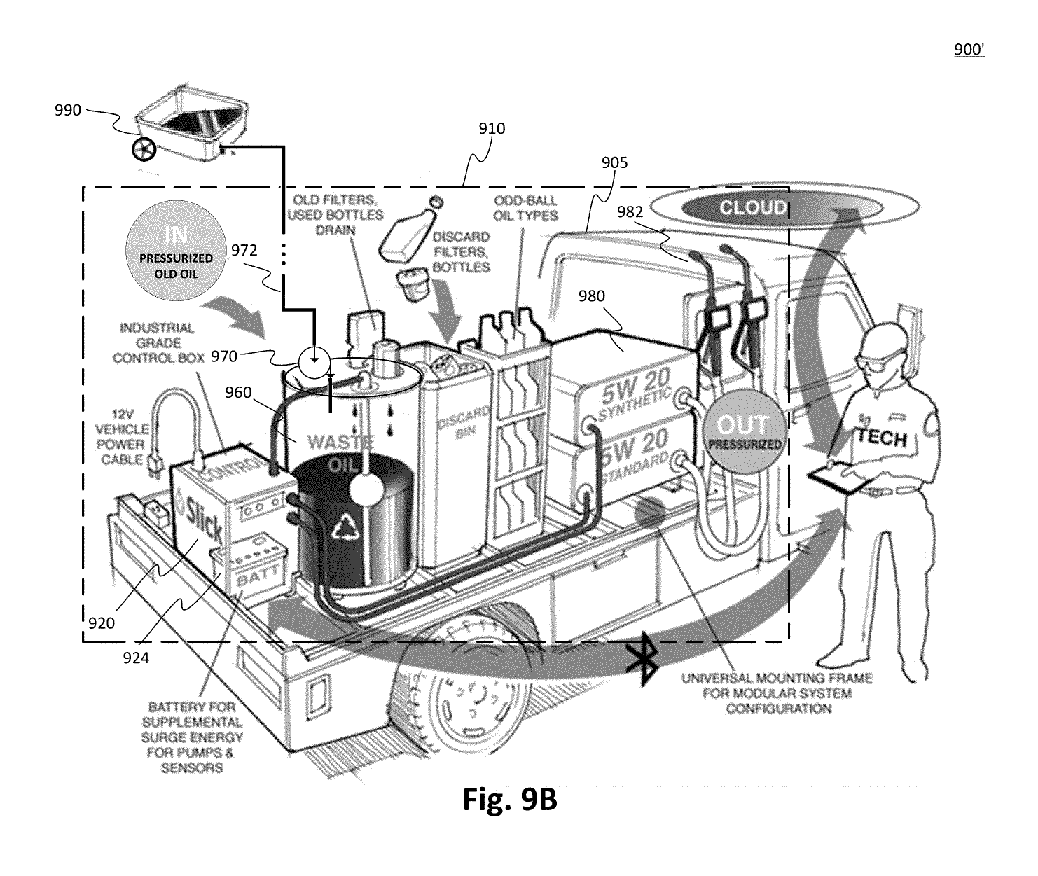

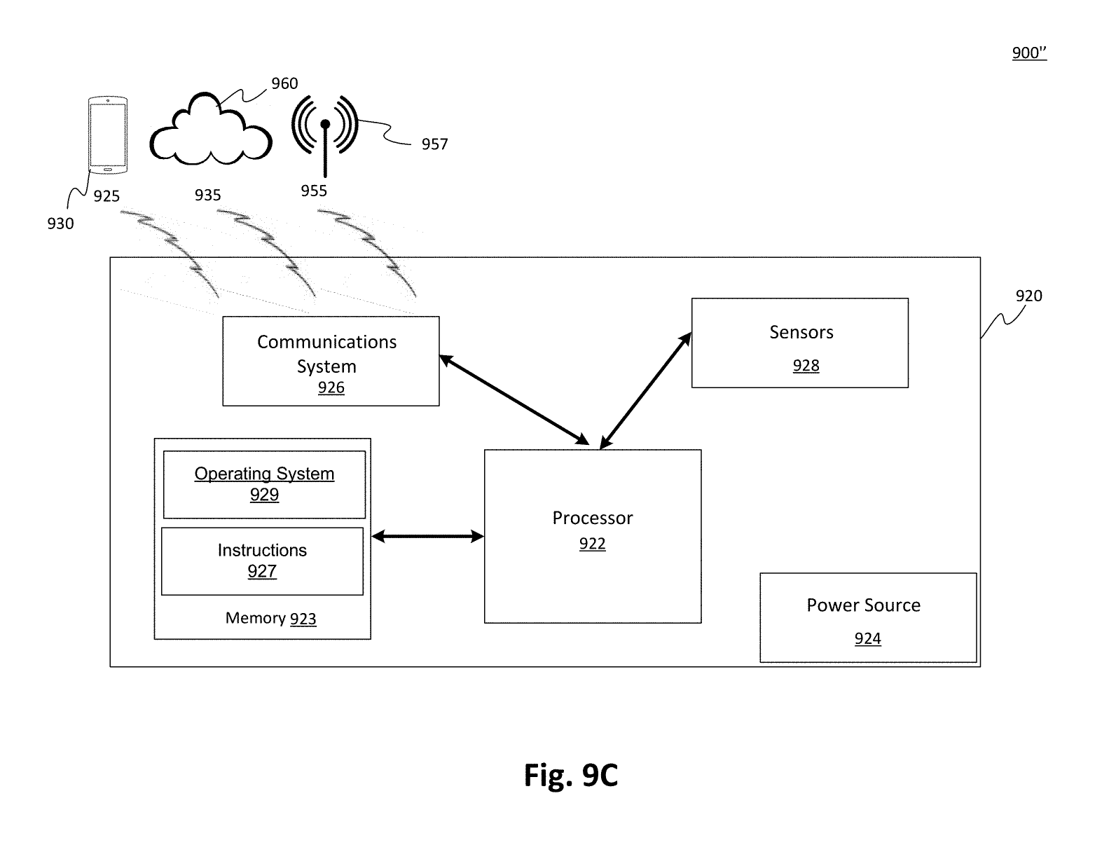

FIG. 9A illustrates an Oil Use Monitoring and Maintenance system 900, according to an embodiment. Oil Use Monitoring and Maintenance system 900 includes a vehicle 905, a fully contained maintenance fluid vacuum system 910, a technician 915, a control system 920, a power source 924, a mobile communication device 930 and a cloud 960. Communications between control system 920 and mobile communication device 930 is via Bluetooth pathway 925 and then through pathway 945 to cloud 960. Communication between control system 920 and cloud 960 can be directly via pathway 935, or through WiFi hotspot 957 using pathways 955 and 959. “Oil Use Monitoring and Maintenance,” while primarily directed to the use of engine oil, is also applicable to any vehicle maintenance fluid, including but not limited to brake fluid, transmission fluid, windshield washer fluid or the like.

Oil Use Monitoring and Maintenance (OUMM) system 900 uses vehicle 905 equipped with a fully contained maintenance fluid vacuum system 910 that includes oil storage tanks, waste oil containers, and control system 920 with multiple sensors and pumps to allow for the monitoring and transfer of fresh and waste oil and their corresponding levels. OUMM system 900 is designed to arrive at a delivery point, e.g., a customer site, as a result of a notification originated by SVP system 100 for a vehicle/engine oil change, or by SEP system 600 for maintenance of a fleet of mowers 672. Such notification by SVP system 100 or SEP system 600 could be automatic, without the need for technician intervention.

Control system 920 is designed to have knowledge of all of the oil inflow and outflow amounts. Further, control system 920 can relay the pertinent information to cloud 960 on an as necessary basis, including real time. Control system 920 also contains power source 924 as an energy store for supplemental surge energy such as for pumps and sensors. Power source 924 ensures that vehicle 905 does not need to be run constantly when at a service site and saves money with fuel cost, etc. accordingly.

FIG. 9B further illustrates details and an embodiment of a mobile OUMM system 900′ according to an embodiment. FIG. 9B includes vehicle 905 with a fully contained maintenance fluid vacuum system 910 that includes control system 920, power source 924, a waste oil tank 960, a waste recovery pump 970, a waste recovery line 972, a maintenance fluid delivery storage tank 980, a delivery nozzle 982 and a collection container 990. Further, waste oil tank 960 can consist of one or more tanks including any type container. In addition, maintenance fluid delivery storage tank 980 can consist of multiple tanks containing multiple type of fluids, including oil of one or more types, or any other maintenance fluid including but not limited to brake fluid, transmission fluid, windshield washer fluid or the like. Collection container 990 can be any type of container, including one, as shown, that includes wheels for ease of movement.

Mobile OUMM system 900′, in an embodiment, can be used to perform a mobile oil change on an engine. Currently, mobile oil changes are typically performed using a method commonly referred to as the ‘gravity method.’ This method involves a person placing a standalone drain pan under the engine sump, pulling the sump plug, and allowing the waste oil to drain into the drain pan. The person then has to carefully remove the drain pan, now filled with 4-12 quarts of hot waste oil, by hand, to a larger receptacle, such as a bucket, or by putting a cap on the drain pan itself, which is also now covered in hot oil. The outside surface of this drain pan must be thoroughly cleaned, and the cleaning rags properly disposed of as they are now contaminated. The waste oil is then transported in either the capped off waste receptacle or the sealed drain pan, to a proper facility. Waste oil is a toxic substance to both the environment and the handler. The container could drop and spill, contaminating the environment and injuring or burning the handler.

Another method for changing vehicle oil is a “manual vacuum method,” which usually involves either snaking a tube down the dipstick hole, creating a vacuum with a hand pump, and then drawing out the waste oil into a container. Only vehicles specifically designed for this method should use this method, as particles at the bottom of the sump, could damage the engine as they are drawn up into the suction tube. This method involves a human handling the pressurized container during and after the oil changing process. Further, the container could drop and spill, contaminating the environment and injuring or burning the handler. Another version of the vacuum method involves a tow behind oil vacuum system that replaces the handheld pump; this pump can be connected to a drain pan placed under the vehicle. This method is commonly used in the military, industrial and agricultural fields. It carries its own risks to the environment because it is exposed to the elements, and leaking can occur at the connection points of the drain pan and the hose connecting the drain pan to the system.

In contrast mobile OUMM system 900′ utilizes a fully contained maintenance fluid vacuum system that includes control system 920, power source 924, waste oil tank 960, waste recovery pump 970, waste recovery line 972, maintenance fluid delivery storage tank 980, delivery nozzle 982 and collection container 990, in an embodiment. These components reside in or on service vehicle 905 that is designed to automate the service delivery for consumer and fleet vehicles, which can be performed in an on-demand fashion, triggered by a mobile application as previously discussed. Mobile OUMM system 900′ can utilize rectangular storage tanks, e.g., maintenance fluid delivery storage tank 980 or waste oil tank 960, to make the most efficient use of space within the service vehicle. The system also uses top-mounted pumps, e.g., waste recovery pump 970, so in the event of a leak at the location of the pump, the contents of the tank will not expel. OUMM system 900′ can use dry-brake technology to create leakproof connections from waste recovery pump 970 to a wheeled collection container 990 that can be slid under a vehicle and act as a repository for the waste oil and drain location for the used oil filter. When the job is done, the vacuum is engaged through the use of waste recovery pump 970 and waste recovery line 972 which draws the waste oil from collection container 990 directly into onboard waste oil tank 960 on vehicle 905.

In an embodiment, mobile OUMM system 900′ can dispense fresh oil via onboard dispensing reels and delivery nozzle 982 to receive fresh oil in bulk from shop-based bulk oil tanks, further reducing the need for a human to handle oil in a container, potentially dropping it or contaminating or harming himself

FIG. 9C illustrates further details of control system 920 in OUMM systems 900′ and 900″, according to an embodiment. FIG. 9C shows that control system 920 also includes a processor 922 with memory 923, a communications system 926 and sensors 928. Memory 923 contains an operating system 929 and further executes instructions 927. Communications system 926 is configured to operate on one or more types of communication protocols, including a Bluetooth pathway 925 to mobile communication device 930, using WiFi pathway 955 to WiFi hotspot 957, and using cellular pathway 935 to cloud 960. Sensors 928 may consist of sensors located within control system 920 or the sensors could be externally located, for example in the waste oil storage tank or in the new oil holding tanks. Communications between control system 920 and sensors 928 can either be wired or wireless, depending upon the sensor and desired flexibility. Further, sensors can include video cameras to provide real-time monitoring and/or as a basis for training and process improvement.

Information from control system 920 can be relayed through mobile communication device 930 to technician 915, or to cloud 960 for further analysis. After analyzing, either the cloud or technician 915 can respond with commands or instructions for control system 920. Information from sensors 928 and feedback from cloud 960 may include of the following:
Length of time to vacuum out the oil;
Time for the technician to transition from vacuuming out the oil to putting in new oil;
Indications that there was wasted fresh oil above and beyond the manufacturers spec for a particular vehicle;
Work flow changes that could be implemented to increase efficiency;
Indication that any oil was stolen;
Analysis of life cycle of the pumps or other wearable sub-systems in the delivery systems;
Status of any of the power sources, e.g., batteries; and
Comparative performance levels of multiple technicians.

OUMM system 900 could further include a global positioning system (GPS) that would enable the tracking of the vehicle 905 via cloud 960. Further, a “spill alert” alarm system could be integrated such as if a full tank spills over or any sudden unexpected change in storage level would alert a technician or cloud 960 in real-time of a potential spill issue, thus averting expensive clean-up expenses and possible fines.

Methods

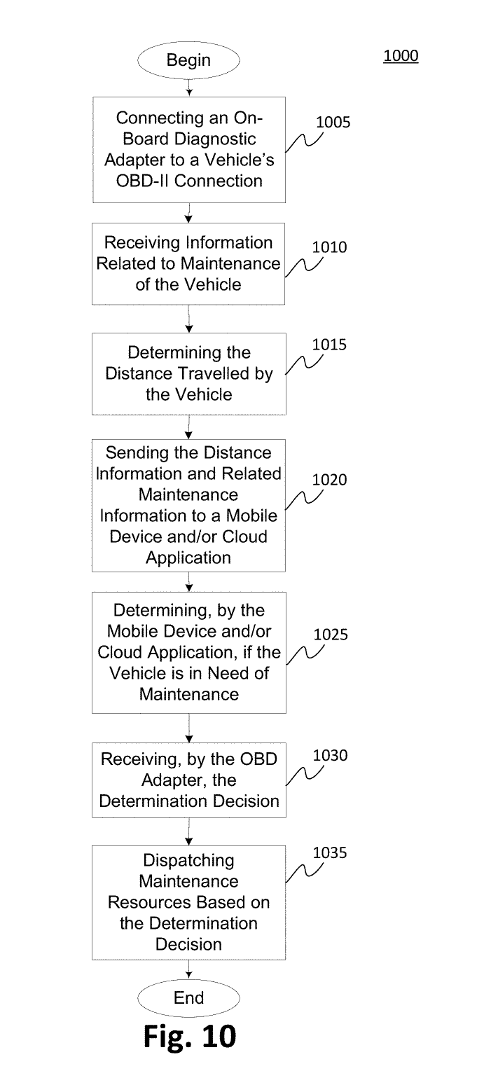

FIG. 10 shows an exemplary embodiment of a method 1000 for determining maintenance of a vehicle using a standard vehicle platform, according to an embodiment. Method 1000 begins at step 1005 with the connecting of an on-board diagnostic adapter to a vehicle's OBD-II connector. For example, FIG. 1 illustrates a SVP system 100, according to an embodiment, that includes a vehicle 110, an OBD-II adapter 120, a mobile communication device 130, a WiFi hotspot 140, a cellular tower 150 and access to cloud computing 160. OBD-II adapter 120 captures information from vehicle 110 through vehicle 110's OBD-II connector. Method 1000 continues to step 1010 with receiving information related to maintenance of the vehicle. The receipt of maintenance information is also shown and discussed in FIG. 1 where the OBD adapter gathers parameter identifier codes (“PID”) from vehicle 110 to calculate real-time odometer values and where OBD-II adapter 120 can also capture any other relevant PID codes and store those in its internal memory, and/or communicate the information in real time to cloud 160. Such information can also include information from sensors designed to detect various movement and environmental conditions, e.g., acceleration, vibration, gyroscopic, tilt, humidity, proximity movement, temperature, air quality, acoustic, smoke, microphone, carbon monoxide, impact, occupancy, altitude, etc. Sensors can either be internal to OBD-II adapter, such as sensors 295, or external to OBD-II adapter, such as external sensors 297.

Maintenance information can also include electrical system analysis as illustrated in FIG. 3, where in addition to capturing odometer telemetry, OBD-II adapter 220 has the ability to monitor vehicle 210's main battery and charging system health with the analysis of points 320, 330 and 340 showing the system's voltage levels prior to start, at start, and when the alternator engages. In addition, engine air filter performance data can be captured and analyzed by monitoring the PID values (0x50, 0x66, etc.) and with possible input into driving behavior and locations/terrain, altitude, etc. And, cabin air filter performance can be tracked utilizing a battery operated wireless sensor.

Method 1000 continues to step 1015 in determining the distance traveled by the vehicle. This is accomplished, as described in FIG. 2, where OBD-II adapter 220 receives the “distance (km) traveled since codes cleared” OBD-II PID code, which is a 2 byte read at 0x31 hex, which when added to a baseline value entered by a user or technician, yields an actual odometer reading. At step 1020 any distance and related maintenance information is sent to a mobile communication device and/or a cloud application for further analysis and/or storage. As described in FIG. 1, such communications can be directed to and from cloud computing on cloud 160 to mobile communication device 130 running the SVP application, either directly via pathway 145 or routed through OBD-II adapter 120 using pathways 135 and 125.

Method 1000 continues to step 1025 that includes determining, by the mobile communication device and/or a cloud based application if the vehicle is in need of maintenance. For example, in FIG. 1, once the distance traveled by the vehicle is determined, that information can be sent to mobile communication device 130 or directly to cloud 160. In either case the distance traveled is compared to predetermined information pertaining to the year, make and model of vehicle 110 to determine if maintenance is required. And in step 1030, the OBD adapter receives the determination decision made in step 1025. For example, as discussed with FIG. 1, if maintenance is required then an indication can be sent back to OBD-II adapter 120 and/or mobile communication device 130 for further action. And, also as a result of the determination in step 1035, maintenance resources can be dispatched. For example, vehicle 900 as described in Oil Use Monitoring and Delivery system 900 could be dispatched to the service site, thereby providing a managed solution for a standard vehicle platform. Method 1000 then ends.

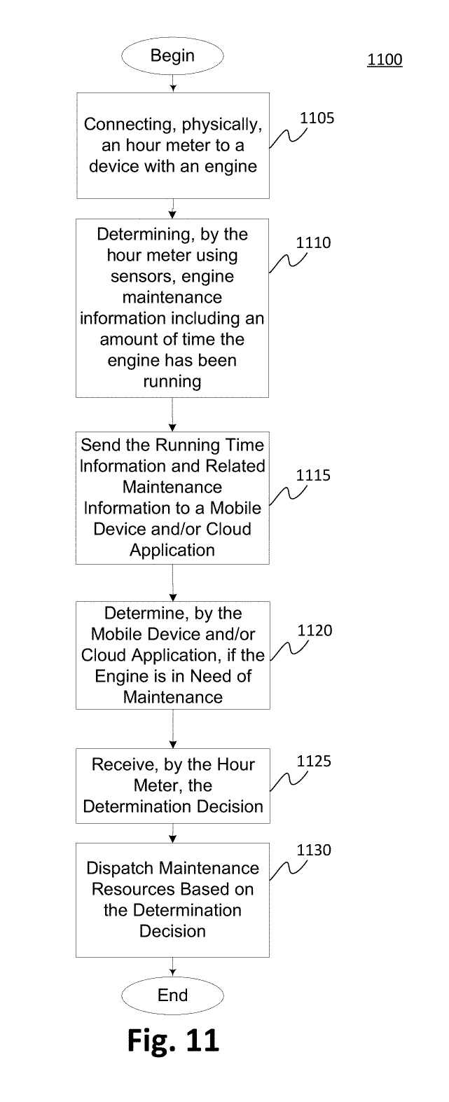

FIG. 11 shows an exemplary embodiment of a method 1100 for determining maintenance on a small engine platform, according to an embodiment. Method 1100 begins at step 1105 with the physical connection of an hour meter to a device with a small engine. For example, FIG. 6 illustrates a SEP system 600, according to an embodiment, that includes a technician 612, a run hour meter 622, a mobile communication device 630, a WiFi hotspot 640, and access to cloud computing 660. The method is also applicable when run hour meter 622 is mounted on any other device with a motor, such as mower 672, a weed-eater 674 and an ATV 676. Once the hour meter is connected, method 1100 advances to step 1110 where the hour meter determines, using sensors, engine maintenance information that includes an amount of time the engine has been running. A possible detail view of a mounted hour meter was shown in FIG. 7, where run hour meter 720 includes a processor 770, a display screen 775, a generator 777, memory 780, a communication system 790 and sensors 795. In an embodiment, sensors 795 are designed to detect vibration and hence determine the time that run hour meter 720 has been running. In addition to detecting vibration, sensors 795 can detect ambient temperature and the actual revolutions per minute of the monitored small engine device in SEP system 700.

In step 1115 the running time information and related maintenance information are sent to a mobile communication device and/or cloud application for further analysis. For example, SEP system 700 includes run hour meter 720 that can communicate with mobile communication device 730 through pathway 725 and then through pathway 745 to cellular tower 750 and then through pathway 752 to cloud 760. Run hour meter 720 can also communicate directly with cloud 760 through pathway 735 to cellular tower 750 and then through pathway 752. In step 1120, the mobile communication device or cloud application determines if the engine is in need of maintenance based on the information sent in step 1115. For example, display 775 is used to communicate information to a user, such as the length of time SEP system 700 has been running, the ambient temperature, the average or maximum revolutions per minute (RPM) of SEP system 700, and the percentage of oil life remaining (such information can also be sent to cloud 760 or mobile communication device 730 for further analysis). The percentage of oil life remaining can be calculated as the time from the last oil change as compared to the recommended oil change hour interval from the manufacturer. Such information can be obtained by run hour meter 720 through its communication system 790 to mobile communication device 730, or to cloud 760. A more accurate calculation of remaining oil life can be determined factoring in ambient temperature and average RPM. Basing oil changes on just run hours does not take into account the stress level of the engine, e.g., run hours during idling versus those running at high RPM and heavy loads are vastly different, and those hours occurring during high ambient temperatures are also more stressful on the engine, and therefore requiring a more frequent oil change maintenance schedule.

At step 1125 the hour meter receives communications from the mobile communication device or cloud application on the need for engine maintenance. For example, in FIG. 7, a determination on whether maintenance is needed can be made by mobile communication device 730 or cloud 760 and then communicated back to run hour meter 720, with the ability to display such information on display 775. And, also as a result of the determination in step 1125, maintenance resources can be dispatched. For example, vehicle 900 as described in Oil Use Monitoring and Delivery system 900 could be dispatched to the service site, thereby providing a technology driven managed maintenance platform for small engine platform systems. Method 1100 then ends.

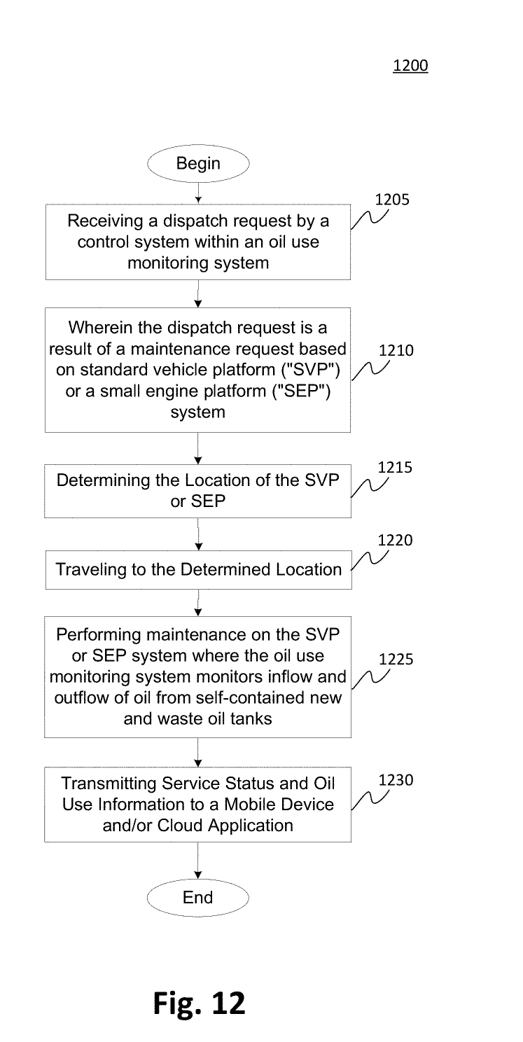

FIG. 12 shows an exemplary embodiment of a method 1200 for oil use monitoring and maintenance, according to an embodiment. Method 1200 begins at step 1205 with the receiving of a dispatch request by a control system within an oil use monitoring and maintenance system. Such a dispatch request can be the result of a maintenance dispatch request for a standard vehicle platform in step 1035 of method 1000, or for a small engine platform maintenance dispatch request in step 1130 of method 1100. Maintenance resources can consist of an oil use monitoring and maintenance system 900 as illustrated in FIG. 9A, according to an embodiment. Oil use monitoring and maintenance system 900 includes a vehicle 905, a technician 915, a control system 920, a mobile communication device 930 and a cloud 960. Oil use monitoring and maintenance (OUMM) system 900 uses vehicle 905 equipped with oil storage tanks, waste oil containers, and control system 920 with multiple sensors to allow for the monitoring of fresh and waste oil levels. OUMM system 900 is designed to arrive at a delivery point, e.g., a customer site, as a result of a notification originated by SVP system 100 for a vehicle oil change, or by SEP system 600 for maintenance of a fleet of mowers 672. Such notification by SVP system 100 or SEP system 600 could be automatic, without the need for technician intervention.

Method 1200 continues to step 1210, where the dispatch request is a result of a maintenance request based on a SVP or SEP system. The request for maintenance could also include GPS coordinates or an address where the system is located. In step 1215 the location of the SVP or SEP is determined. Such a determination would be the result of information received whether from the SVP or SEP directly, or from another source such as mobile communication device 930 or cloud 950 as described in FIGS. 9A and 9B. Location information can also be included within the dispatch request of step 1205. Once the location of the SEP or SVP is determined, in step 1220 the oil use monitoring and maintenance system travels to the determined location. In step 1225 maintenance is performed on the SVP or SEP where the oil use monitoring and maintenance system monitors inflow and outflow of oil from self-contained new and waste oil tanks. For example, control system 920 is designed to have knowledge of all of the oil inflow and outflow amounts. Further, control system 920 can relay the pertinent information to cloud 960 on an as necessary basis, including real time. The oil use monitoring and maintenance system is intended to be offered to consumers as well as for shared vehicle fleets and corporate fleets.

Method 1200 continues with step 1230 that includes transmitting a service status and oil use information to a mobile communication device and/or cloud application. For example, information from control system 920 can be relayed through mobile communication device 930 to technician 915, or to cloud 960 for further analysis. After analyzing, either the cloud or technician 915 can respond with commands or instructions for control system 920. Information from sensors 928 and feedback from cloud 960. Method 1200 then ends.

Example Computer System Implementation

Aspects of the present invention shown in FIGS. 1, 2, 6-12, or any part(s) or function(s) thereof, may be implemented using hardware, software modules, firmware, tangible computer readable media having instructions stored thereon, or a combination thereof and may be implemented in one or more computer systems or other processing systems.

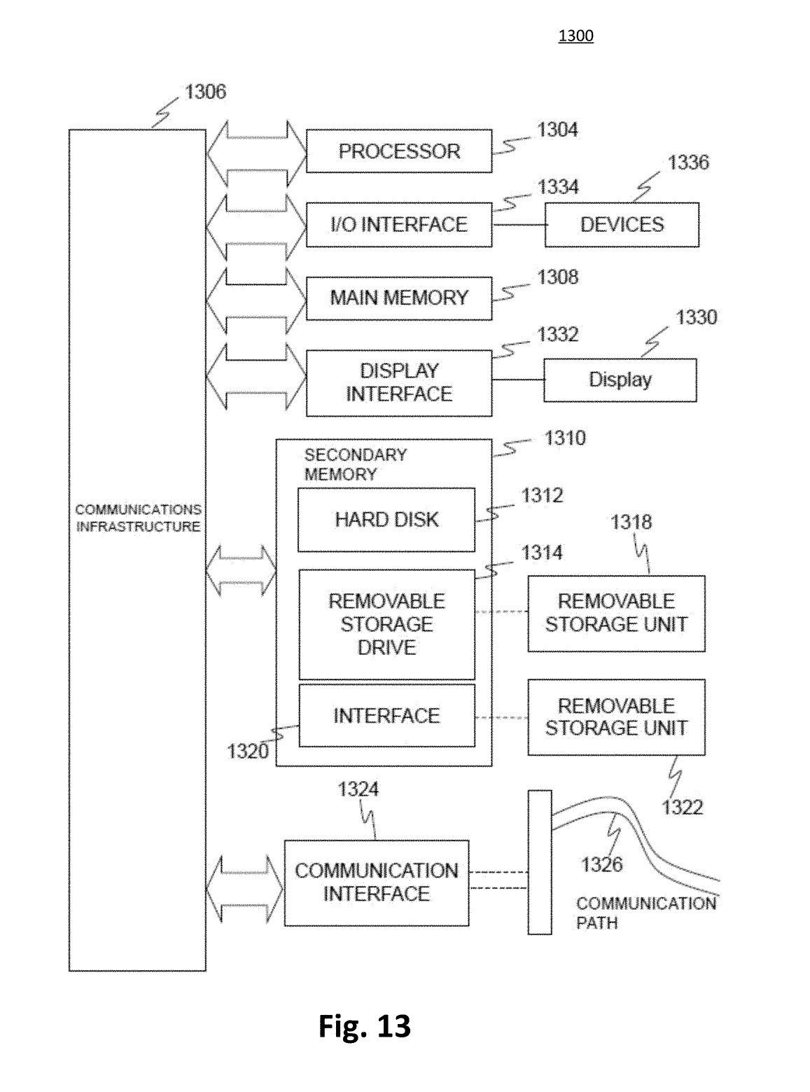

FIG. 13 illustrates an example computer system 1300 in which embodiments, or portions thereof, may be implemented as computer-readable code. For example, portions of OBD-II adapter 120, 220, run hour meter 622, 720, control system 920 and cloud 160, 260, 645, 760, 860, 960 may be implemented in portions of computer system 1300 using hardware, software, firmware, tangible computer readable media having instructions stored thereon, or a combination thereof and may be implemented in one or more computer systems or other processing systems. Hardware, software, or any combination of such may embody any of the modules and components in FIGS. 1, 2 and 6-12.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 1300. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1304 may be a special purpose or a general purpose processor device. As will be appreciated by persons skilled in the relevant art, processor device 1304 may also be a single processor in a multi-core/multiprocessor system, such system operating alone, or in a cluster of computing devices operating in a cluster or server farm. Processor device 1304 is connected to a communication infrastructure 1306, for example, a bus, message queue, network, or multi-core message-passing scheme.

Computer system 1300 also includes a main memory 1308, for example, random access memory (RAM), and may also include a secondary memory 1310. Secondary memory 1310 may include, for example, a hard disk drive 1312, removable storage drive 1314. Removable storage drive 1314 may include a floppy disk drive, a magnetic tape drive, an optical disk drive, a flash memory, or the like. The removable storage drive 1314 reads from and/or writes to a removable storage unit 1318 in a well-known manner. Removable storage unit 1318 may include a floppy disk, magnetic tape, optical disk, etc. which is read by and written to by removable storage drive 1314. As will be appreciated by persons skilled in the relevant art, removable storage unit 1318 includes a computer usable storage medium having stored therein computer software and/or data.

Computer system 1300 (optionally) includes a display interface 1332 (which can include input and output devices such as keyboards, mice, etc.) that forwards graphics, text, and other data from communication infrastructure 1306 (or from a frame buffer not shown) for display on display unit 1330. Computer system 1300 is not limited to a particular design and can be a microcontroller, microprocessor, System on integrated circuit (SOIC), application specific integrated circuit, any combination thereof.

In alternative implementations, secondary memory 1310 may include other similar means for allowing computer programs or other instructions to be loaded into computer system 1300. Such means may include, for example, a removable storage unit 1322 and an interface 1320. Examples of such means may include a program cartridge and cartridge interface (such as that found in video game devices), a removable memory chip (such as an EPROM, or PROM) and associated socket, and other removable storage units 1322 and interfaces 1320 which allow software and data to be transferred from the removable storage unit 1322 to computer system 1300.

Computer system 1300 may also include a communication interface 1324. Communication interface 1324 allows software and data to be transferred between computer system 1300 and external devices. Communication interface 1324 may include a modem, a network interface (such as an Ethernet card), a communication port, a PCMCIA slot and card, wireless communications including WiFi and cellular, or the like. Software and data transferred via communication interface 1324 may be in the form of signals, which may be electronic, electromagnetic, optical, or other signals capable of being received by communication interface 1324. These signals may be provided to communication interface 1324 via a communication path 1326. Communication path 1326 carries signals and may be implemented using wire or cable, fiber optics, a phone line, a cellular link, a WiFi link, or any other RF link or other communication channels.

In this document, the terms “computer program medium” and “computer usable medium” are used to generally refer to media such as removable storage unit 1318, removable storage unit 1322, and a hard disk installed in hard disk drive 1312. Computer program medium and computer usable medium may also refer to memories, such as main memory 1308 and secondary memory 1310, which may be memory semiconductors (e.g. DRAMs, etc.).

Computer programs (also called computer control logic) are stored in main memory 1308 and/or secondary memory 1310. Computer programs may also be received via communication interface 1324. Such computer programs, when executed, enable computer system 1300 to implement the present invention as discussed herein. In particular, the computer programs, when executed, enable processor device 1304 to implement the processes of the present invention, such as the stages in the methods illustrated by flowchart 1000, 1100 and 1200 of FIGS. 10, 11 and 12, as previously discussed. Accordingly, such computer programs represent controllers of the computer system 1300. Where the invention is implemented using software, the software may be stored in a computer program product and loaded into computer system 1300 using removable storage drive 1314, interface 1320, and hard disk drive 1312, or communication interface 1324.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Conclusion

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

1. A vehicle based mobile oil use monitoring and maintenance system comprising:
a motorized dispatch vehicle configured to receive a dispatch request;
a maintenance fluid vacuum system mounted on the motorized dispatch vehicle configured to deliver and recover engine maintenance fluids, comprising a waste collection tank and a waste recovery pump; and
a collection container coupled to the maintenance fluid vacuum system by a waste recovery line,
wherein the collection container is configured to collect the engine maintenance fluids, and
wherein the waste recovery pump transfers the engine maintenance fluids from the collection container to the waste collection tank.

2. The vehicle based mobile oil use monitoring and maintenance system of claim 1, wherein the waste recovery pump is top-mounted on the waste collection tank.

3. The vehicle based mobile oil use monitoring and maintenance system of claim 1, further comprising a delivery storage tank configured to hold new maintenance fluids.

4. The vehicle based mobile oil use monitoring and maintenance system of claim 3, further comprising a nozzle delivery system couple with the delivery storage tank configured to dispense the new maintenance fluids.

5. The vehicle based mobile oil use monitoring and maintenance system of claim 3, wherein the delivery storage tank is rectangular.

6. The vehicle based mobile oil use monitoring and maintenance system of claim 1, wherein the collection container comprises wheels and is placed under a vehicle for collecting maintenance fluids.

7. The vehicle based mobile oil use monitoring and maintenance system of claim 1, wherein the dispatch request is generated by the standard vehicle platform and comprises a location of a standard vehicle platform to be serviced.

8. The vehicle based mobile oil use monitoring and maintenance system of claim 1, wherein the dispatch request is generated by the small engine platform and comprises a location of a small engine platform to be serviced, wherein the small engine platform comprises a non-vehicle device.

9. The vehicle based mobile oil use monitoring and maintenance system of claim 1, further comprising transmitting a service status and a maintenance fluid status to a cloud application.

10. The vehicle based mobile oil use monitoring and maintenance system of claim 1, wherein the dispatch request is generated by an application on a mobile communication device.

11. The vehicle based mobile oil use monitoring and maintenance system of claim 10, wherein the dispatch request is generated based on a communication from an on-board diagnostic adapter coupled to a vehicle equipped with an on-board diagnostic (OBD) system, wherein the OBD system is compliant with the OBD-II, EOBD, JOBD or ADR 79/01 standard.

12. A vehicle based mobile oil use monitoring and maintenance method comprising:
receiving a dispatch request based on a maintenance request from an engine platform system;
determining a location of the engine platform system;
travelling, by a motorized dispatch vehicle, to the determined location; and
performing maintenance on the engine platform system, the maintenance comprising:
deploying a collection container configured to collect engine maintenance fluids, wherein the collection container is coupled, via a waste recovery line, to a maintenance fluid vacuum system mounted on the motorized dispatch vehicle;
collecting engine maintenance fluids; and
transferring the collected engine maintenance fluids from the deployed collection container to a waste collection tank on the motorized dispatch vehicle.

13. The vehicle based mobile oil use monitoring and maintenance method of claim 12, wherein the transferring of the engine maintenance fluids utilizes a top-mounted waste recovery pump couple to a waste collection tank.

14. The vehicle based mobile oil use monitoring and maintenance method of claim 12, further comprising dispensing new maintenance fluids to the engine platform system.

15. The vehicle based mobile oil use monitoring and maintenance method of claim 12, wherein the engine platform system is a standard vehicle platform.

16. The vehicle based mobile oil use monitoring and maintenance method of claim 12, wherein the engine platform system is a small engine platform comprising a non-vehicle device.

17. The vehicle based mobile oil use monitoring and maintenance method of claim 12, further comprising transmitting a service status and a maintenance fluid status to a cloud application.

18. The vehicle based mobile oil use monitoring and maintenance method of claim 12, further comprising transmitting a service status and a maintenance fluid status to a mobile communication device, wherein the mobile communication device determines if a dispatch request is to be generated.

19. The vehicle based mobile oil use monitoring and maintenance method of claim 12, wherein the received dispatch request is determined and generated by an application on a mobile communication device.

20. The vehicle based mobile oil use monitoring and maintenance method of claim 18, wherein the received dispatch request is generated based on a communication from an on-board diagnostic adapter coupled to a vehicle's on-board diagnostic (OBD) system, wherein the OBD system is compliant with the OBD-II, EOBD, JOBD or ADR 79/01 standard.
